(19) United States
(12) Patent Application Publication
(10) Pub. No.: US 2026/0214358 A1
(43) Pub. Date: Jul. 23, 2026

(54) Ultra-High-Framerate and Continuous-Readout Pixel For Image Sensor

(71) Applicants: Yuanyuan Hua, Edinburgh (GB); Maciej Stanislaw Wojtkiewicz, Edinburgh (GB)

(72) Inventors: Yuanyuan Hua, Edinburgh (GB); Maciej Stanislaw Wojtkiewicz, Edinburgh (GB)

(21) Appl. No.: 19/452,767

(22) Filed: Jan. 19, 2026

Related U.S. Application Data
(60) Provisional application No. 63/747,169, filed on Jan. 20, 2025.

(51) Int. Cl. H04N 25/773; H04N 25/771; H04N 25/78

(52) U.S. Cl. CPC H04N 25/773; H04N 25/771; H04N 25/78

(57) ABSTRACT

This invention is related to pixel design for ultra-high-framerate and continuous-readout image sensors, especially single photon avalanche diode (SPAD) and complementary metal-oxide-semiconductor image sensor (CIS). The apparatus and method for an ultra-high-framerate and continuous-readout image sensor is provided. A memory circuit containing two memory banks is operated in an interleaved way, while one memory bank is receiving the radiation intensity data, another memory bank is being read out, ensuring all image information is collected without time gaps between frame bursts. Example embodiments including pixels using SPADs, and an image sensor utilizing the pixels are provided.

This application is a continuation of application Ser. No. 63/747,169 filed Jan. 20, 2025.

### TECHNOLOGICAL FIELD

Embodiments of the present disclosure relate generally to image sensors and cameras, and more particularly, to image sensors and cameras operating at ultra-high framerates.

### BACKGROUND

This invention relates to a pixel design for ultra-high-framerate and continuous-readout image sensors, especially single photon avalanche diode (SPAD) and complementary metal-oxide-semiconductor image sensor (CIS). An ultra-high-framerate image sensor is an imaging device capturing frames at the rate of millions per second, allowing it to record transient events or fast-moving subjects with fine details. Patent Document 1 discloses the design of a high-framerate charge coupled device (CCD) image sensor, which has been applied in many practical imagers, realized in CCD and CIS technologies. FIG. 1 illustrates the readout process of a prior-art ultra-high-framerate image sensor. Prior-art ultra-high-framerate image sensors rely on capturing only a finite number of frames, which are first stored in memory circuits and later read out, in a process termed a frame burst 110. However, there is a time gap 120 between the two frame bursts 110 while the acquisition of new frames is stopped until the readout is finalized and memory circuits are ready for another frame burst 110 of frames. Image information in the time gap 120 is permanently lost and cannot be recovered.

FIG. 2 illustrates a block diagram of a prior-art ultra-high-framerate pixel 210 utilizing memory circuits 230 for storage of the radiation information captured by a radiation detector 220 for a number of N frames. After the frame burst 110 is acquired, the memory circuits 230 are read out by readout circuits 240 which drive the pixel output 250. In order to maximize the length of the frame burst 110 before the recording is stopped and the frame readout out of the pixel commences, it is desired that the capacity of the memory circuits 230 is maximized.

An example of practical prior-art ultra-high-framerate pixel layout realized in the CCD technology is disclosed in Patent Document 2. FIG. 3 illustrates an example layout floorplan of the prior-art ultra-high-framerate pixel 210 manufactured in a monolithic process on a single semiconductor wafer. It is apparent that the memory circuits 230 consume a notable area of the pixel, decreasing the area available for the radiation detector 220. This is highly undesirable, as the pixel fill factor, defined as a ratio of the sensitive area to the total pixel area, and thus its sensitivity to radiation, are decreased. Therefore, a designer must balance the trade-off between the memory circuits 230 capacity defining the frame burst 110 length, and the decrease in pixel sensitivity to radiation. Non-Patent Document 1 discloses an ultra-high-framerate CIS image sensor manufactured in 180 nm CIS technology, operating with the frame burst 110 length of 368 frames and achieving a 24% pixel fill factor whilst having a pixel size of 70 μm×35 μm, hindering the development of high-resolution high-sensitivity image sensors at low cost. Indeed, the pixel array resolution reported in the Non-Patent Document 1 is 50×108 pixels (5400 pixels in total), while state-of-the-art low-speed CIS have pixel arrays counting up to hundreds of millions of pixels.

Non-Patent Document 2 discloses an improved design of the 70 μm×35 CIS image sensor. FIG. 4 illustrates a block diagram of a general implementation of an improved ultra-high-framerate image sensor 410 where the memory circuits 230 for storage of the radiation information for a number of N frames are moved outside of the pixel 420 and placed below the pixel array 430. Row address 440 signal is supplied to pixel address decoder and driver circuits 450, and memory address 460 signal is supplied to memory address decoder and driver circuits 470, such as pixels 420 and memory circuits 230 are driven through row select 480 signals and memory row select 490 signals, respectively, to store the radiation information in a frame burst 110 of N frames, acquired at ultra-high-framerate, in memory circuits 230. The radiation information for each frame captured by the pixels 420 is settled row-by-row at columns 4100 and stored in corresponding memory circuits 230. Stored frames are later read out at lower speed through column processing and readout circuits 4110 and output by sensor output circuits 4120 as a sensor output signal 4130.

Although this design choice removes the constraint on the pixel fill factor and the decrease in sensitivity present in the solutions involving in-pixel memory circuits, the fundamental limitation of the recording time dependent on the capacity of memory circuits 230 still exists. Moreover, due to the complex structure, power consumption of the ultra-high-framerate image sensor 410 is high, and memory circuits 430 consume significant silicon area increasing the cost of the imager. Indeed, the imager disclosed in Non-Patent Document 2 allows for the acquisition of only 256 frames in one frame burst 110, and consumes 10 W of power.

In this invention, a pixel design is provided that allows for a continuous in-pixel frame capture and readout, ensuring the entire image information is collected without time gaps 120 between frame bursts 110. FIG. 5 shows the readout process of the disclosed pixel. Image frames are acquired and read out simultaneously, allowing for continuous recording 510 with no missed events. Additionally, some of the disclosed embodiments of the invention are removing the need for the large capacity of the in-pixel memory circuits and thus provide a pixel design ready to implement in a monolithic process on a single semiconductor wafer, achieving a high fill factor and improved radiation sensitivity at low cost and with low power consumption. Other embodiments of the invention allow for maximizing of the exposure time and for detection of the radiation for the entire frame time.

Here, the design of a SPAD sensor is shown as an example to illustrate the continuous ultra-high-framerate imaging method. SPAD-based pixels are natively digital and respond to a single photon entering the diode with a microscopic current termed an “avalanche”, triggered by the first photogenerated electron. The device gain is “infinite” and therefore there is no associated readout noise. This can allow for a photon shot noise (PSN) limited imaging, where the only noise source is the PSN resulting from the quantum nature of electromagnetic radiation, and inherent to all imaging technologies. SPAD pixels can count incoming photons providing a digital number as the pixel output, alleviating the need to apply the time and power-consuming analog-to-digital conversion.

It would be desirable to provide an ultra-high-framerate image sensor offering continuous capture of the unlimited number of frames and having a reduced readout noise, preferably allowing for the photon shot noise limited operation.

Similarly, it would be desirable to provide an image sensor providing exposure times close to the total frame time, in order to maximize the amount of sensed radiation, reducing the PSN and capturing all image information, without a gap between the exposures of consecutive frames.

Applicant has identified many technical challenges and difficulties associated with obtaining a continuous-readout of an ultra-high-framerate pixel applicable for an image sensor or camera. Through applied effort, ingenuity, and innovation, Applicant has solved problems related to obtaining a continuous-redout of an ultra-high-framerate pixel applicable for an image sensor or camera by developing solutions embodied in the present disclosure, which are described in detail below.

### CITATIONS LIST

Patent Document 1: U.S. patent application Ser. No. 07/925,219
Patent Document 2: Japanese Patent No. JP2010146856A
Non-Patent Document 1: S. Manabu, R. Kuroda, and S. Sugawa, “Over 100 Million Frames per Second 368 Frames Global Shutter Burst CMOS Image Sensor with In-pixel Trench Capacitor Memory Array,” in Proceedings of the 2019 International Image Sensor Workshop, pp. 23-27, Snowbird, UT, USA, 2019
Non-Patent Document 2: S. Shigetoshi, R. Kuroda, T. Takeda, F. Shao, K. Miyauchi, and Y. Tochigi, “A 20 Mfps global shutter CMOS image sensor with improved sensitivity and power consumption,” in Proceedings of the 2015 International Image Sensor Workshop, pp. 166-169, Vaals, The Netherlands, 2015

### BRIEF SUMMARY

Various embodiments are directed to an example memory circuit for an ultra-high-framerate continuous-readout pixel, an example method of operating the memory circuit for an ultra-high-framerate continuous-readout pixel, an example ultra-high-framerate continuous-readout pixel, and an example ultra-high-framerate continuous-readout image sensor.

In a first aspect of the invention there is provided a memory circuit for an ultra-high-framerate continuous-readout pixel comprising two memory banks operated in an interleaved way, while one is receiving radiation intensity information and the other is being read out; a demultiplexer directing the radiation intensity data to either odd memory bank or even memory bank according to a memory bank address signal; a memory address decoder choosing said memory bank for the read out; and a readout and pixel output driving circuits block driving the output terminals of the memory circuit based on a row select signal; wherein the radiation intensity data is input to the demultiplexer, the outputs of said demultiplexer are connected to the inputs of said memory banks, and the outputs of said memory banks are connected to said readout and pixel output driving circuits block.

In a second aspect of the invention there is provided a method of operating the memory circuit for an ultra-high-framerate continuous-readout pixel comprising setting a demultiplexer to direct the radiation intensity data to the odd memory bank; writing the radiation intensity data to the odd memory bank for a number of N frames; simultaneously reading out a previously stored series of N frames from the even memory bank to the outside of the memory circuit; setting a demultiplexer to direct the radiation intensity data to the even memory bank once the writing of the N frames to the odd memory bank is complete; writing the radiation intensity data to the even memory bank for a number of N frames; simultaneously reading out a previously stored series of N frames from the odd memory bank to the outside of the memory circuit; and repeating said steps as long as needed for the desired number of frames to be recorded.

In a third aspect of the invention there is provided an ultra-high-framerate continuous-readout pixel comprising a sensing device converting the input radiation intensity into an electrical signal; frontend circuits biasing and reading out the sensing device; and a memory circuit; wherein the output of said sensing device is input to the frontend circuits, and the output of said frontend circuit is connected to the inputs of said memory circuits. The memory circuit comprising two memory banks working in an interleaved way, while one is receiving radiation intensity information and the other is being read out; a demultiplexer directing the radiation intensity data to either odd memory bank or even memory bank according to the memory bank address signal; a memory address decoder choosing said memory bank for the read out; and a readout and pixel output driving circuits block driving the output terminals of the memory circuit based on the row select signal; wherein the radiation intensity data is input to the demultiplexer, the outputs of said demultiplexer are connected to the inputs of said memory banks, and the outputs of said memory banks are connected to said readout and pixel output driving circuits block.

In a fourth aspect of the invention there is provided an ultra-high-framerate continuous-readout image sensor comprising a pixel array comprising a plurality of pixels arranged in a two-dimensional shape comprising rows and columns. Each pixel comprising a sensing device converting the input radiation intensity into an electrical signal; frontend circuits biasing and reading out the sensing device; and a memory circuit; wherein the output of said sensing device is input to the frontend circuits, and the output of said frontend circuit is connected to the inputs of said memory circuits. The memory circuit comprising two memory banks working in an interleaved way, while one is receiving radiation intensity information and the other is being read out; a demultiplexer directing the radiation intensity data to either odd memory bank or even memory bank according to the memory bank address signal; a memory address decoder choosing said memory bank for the read out; and a readout and pixel output driving circuits block driving the output terminals of the memory circuit based on the row select signal; wherein the radiation intensity data is input to the demultiplexer, the outputs of said demultiplexer are connected to the inputs of said memory banks, and the outputs of said memory banks are connected to said readout and pixel output driving circuits block.

Other aspects of invention are described in the appended independent and dependent claims.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a prior-art ultra-high-framerate pixel readout process.

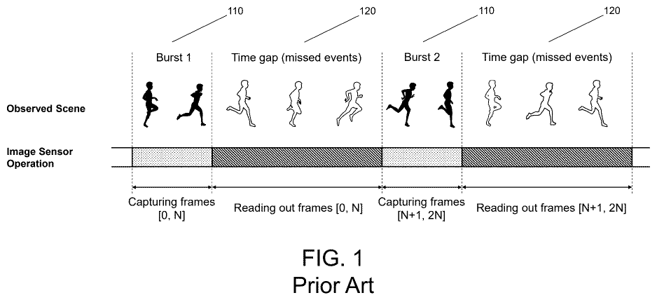

FIG. 2 illustrates a prior-art ultra-high-framerate pixel utilizing memory circuits for storage of the radiation information for a number of N frames.

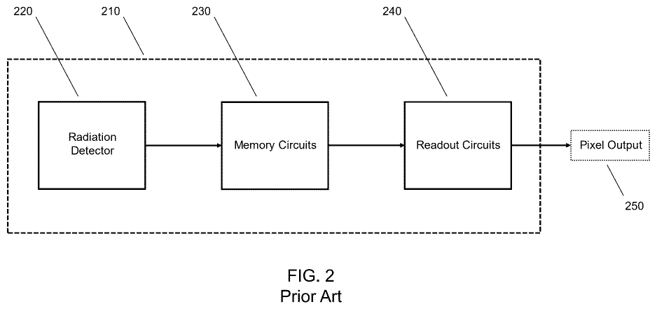

FIG. 3 illustrates an example layout floorplan of a prior-art ultra-high-framerate pixel manufactured in a monolithic process on a single semiconductor wafer.

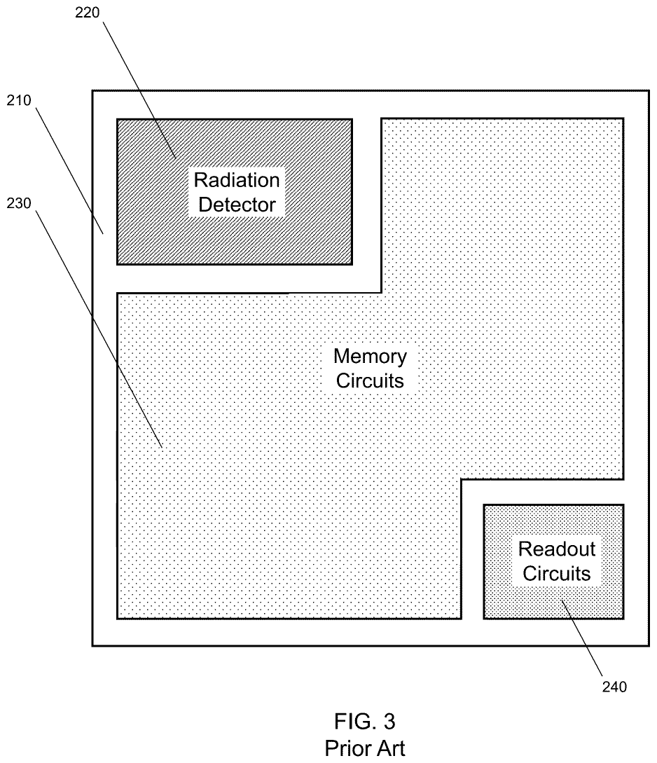

FIG. 4 illustrates a block diagram of a prior-art ultra-high-framerate sensor where the memory circuits for storage of the radiation information for a number of N frames are moved outside of the pixel array.

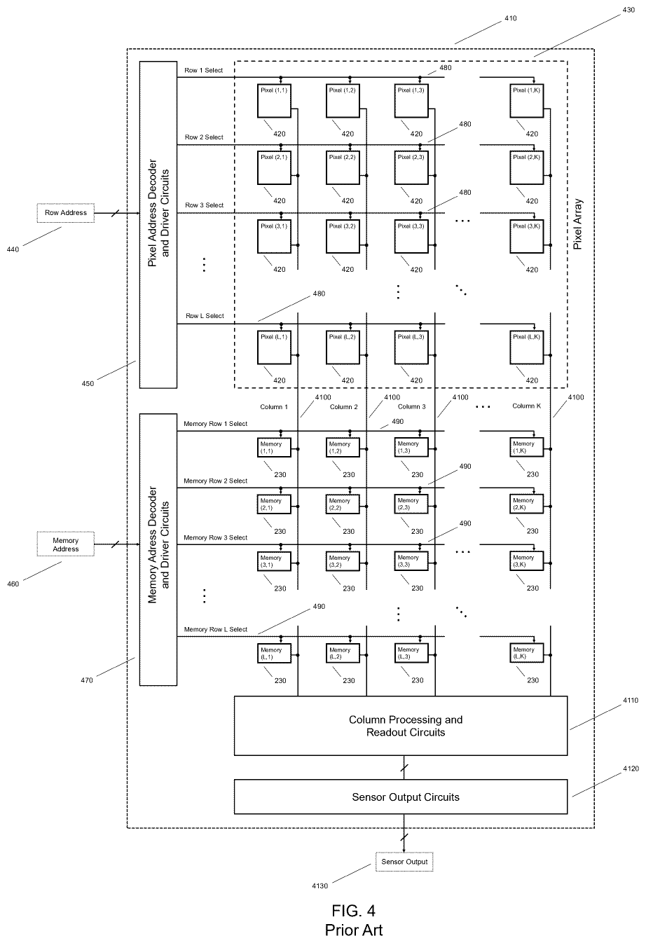

FIG. 5 illustrates a continuous ultra-high-framerate pixel readout process.

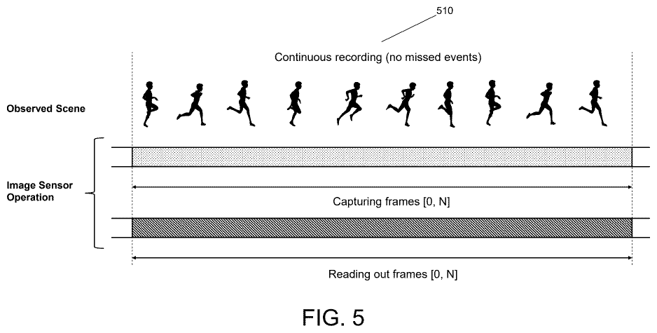

FIG. 6 illustrates a block diagram of an ultra-high-framerate continuous-readout SPAD pixel in accordance with an example embodiment of the present disclosure.

FIG. 7 provides a graph illustrating a timing diagram of an ultra-high-framerate continuous-readout SPAD pixel in accordance with an example embodiment of the present disclosure.

FIG. 8 illustrates a block diagram of an ultra-high-framerate continuous-readout SPAD pixel implemented with two photon counters in accordance with an example embodiment of the present disclosure.

FIG. 9 provides a graph illustrating a timing diagram of an ultra-high-framerate continuous-readout SPAD pixel using a memory circuit implemented with two photon counters in accordance with an example embodiment of the present disclosure.

FIG. 10 illustrates a block diagram of an ultra-high-framerate continuous-readout SPAD pixel implemented with two photon counters without counter reset signal in accordance with an example embodiment of the present disclosure.

FIG. 11 provides a graph illustrating a timing diagram of an ultra-high-framerate continuous-readout SPAD pixel implemented with two photon counters without counter reset signal in accordance with an example embodiment of the present disclosure.

FIG. 12 provides a graph illustrating the comparison of exposure times in state-of-the-art pixels and the ultra-high-framerate continuous-readout SPAD pixel implemented with two photon counters in accordance with an example embodiment of the present disclosure.

FIG. 13 illustrates a schematic diagram of an ultra-high-framerate continuous-readout pinned photodiode pixel using two transfer gates in accordance with an example embodiment of the present disclosure.

FIG. 14 illustrates an example layout of an ultra-high-framerate continuous-readout pinned photodiode pixel using two transfer gates in accordance with an example embodiment of the present disclosure.

FIG. 15 illustrates a schematic diagram of a memory circuit implemented as shift registers in accordance with an example embodiment of the present disclosure.

FIG. 16 illustrates a block diagram of an ultra-high-framerate continuous-readout pinned photodiode pixel using a memory circuit in accordance with an example embodiment of the present disclosure.

FIG. 17 illustrates a block diagram of an image sensor based on the ultra-high-framerate continuous-readout SPAD pixel using a memory circuit in accordance with an example embodiment of the present disclosure.

FIG. 18 provides a graph illustrating a readout timing diagram of the image sensor based on the ultra-high-framerate continuous-readout SPAD pixel using a memory circuit in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

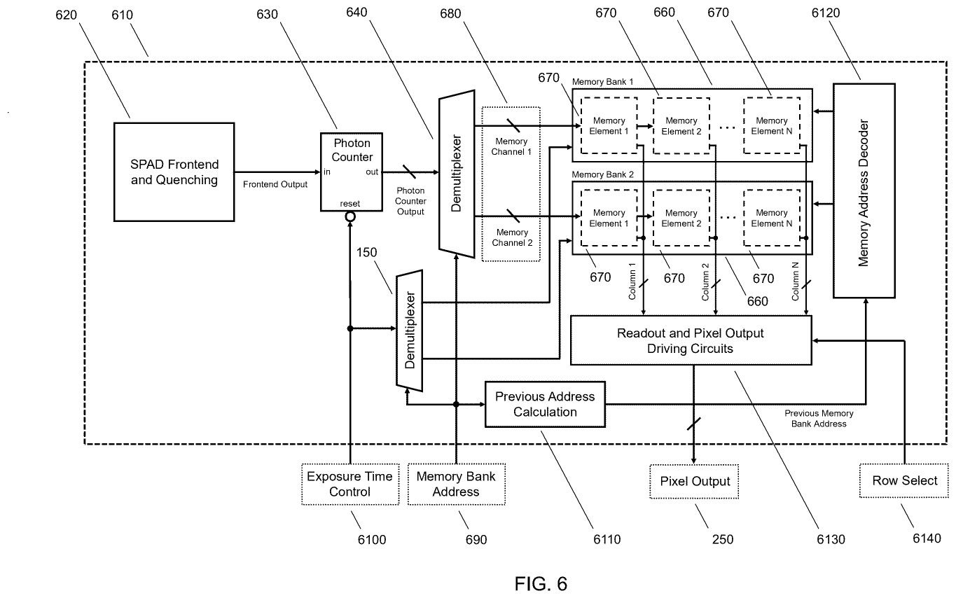

FIG. 6 shows a block diagram of an ultra-high-framerate continuous-readout SPAD pixel 610. The pixel utilizes two memory banks 660 to achieve a continuous capture and readout of the unlimited number of frames. Two memory banks are activated in the alternate fashion, while one of them is active for the write operation, the other bank is available for the readout of the previously captured data. Thanks to this, there is no time gap between the two frame series and no image information is lost during the pixel readout.

Each memory bank 660 may contain a plurality of memory elements 670. A series of N frames may be stored in the memory bank 660, allowing for the N times increased time available to readout the data from the pixel, provided the pixel output 250 consists of a bus composed of a plurality of parallel wires.

The ultra-high-framerate continuous-readout SPAD pixel 610 shown on the FIG. 6 utilizes a SPAD device, which is interfaced to the pixel circuit by a SPAD quenching and frontend block 620. Output of the SPAD quenching and frontend block 620 is connected to a photon counter 630, which provides a digital count corresponding to the number of the input SPAD pulses. The photon counter output is connected to a demultiplexer 640. Based on a memory bank address 690, one of the memory channels 680 is selected and used to store the photon counts for each frame in the series. The memory channels 680 are connected to the two memory banks 660, storing the photon count in a suitable memory element 670. An exposure time control signal 6100 is used to reset the photon counter 630 between the capture of the subsequent frames and to shift the photon count written in the memory bank 660 to the next memory element 670. The exposure time control signal 6100 is provided to an exposure time control demultiplexer 150 directing said signal to the currently selected memory bank 660. Consequently, the photon counts are shifted between the subsequent memory elements 670 only in the active memory bank 660. The detailed implementation of the shifting operation may depend on the used memory type and circuits in the memory bank 660.

Memory bank address 690 is provided to the previous address calculation block 6110. Based on the calculated previous memory bank address, memory address decoder 6120 selects the memory bank 660 for the pixel readout. While the photon counts corresponding to the new frames are being written to one of the memory banks 660, the other bank is used to readout the previously stored N frames out of the pixel circuit. The corresponding photon counts are made available on the column buses connecting memory banks 660 to the readout and pixel output driving circuits block 6130. Based on a row select signal 6140, the readout and pixel output driving circuits block 6130 outputs the photon counts to the pixel output 250.

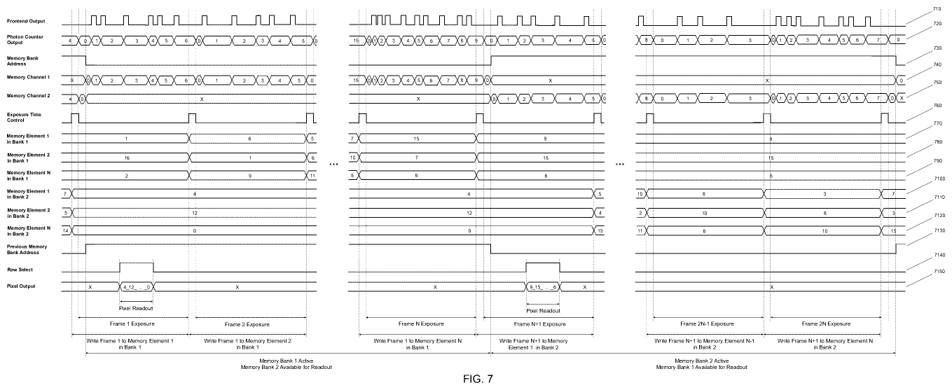

FIG. 7 shows a timing diagram of the ultra-high-framerate continuous-readout SPAD pixel 610. A frontend output trace 710 shows a sample train of digital pulses representing detected incoming photons. Every rising edge of the frontend output trace 710 marks the arrival of a photon. A photon counter output trace 720 shows a corresponding digital count provided by the photon counter 630. When a memory bank address trace 730 is equal to the logic low, the photon count is demultiplexed to the memory channel 1, as shown on memory channel 1 trace 740. Conversely, when the memory bank address trace 730 is equal to the logic high, memory channel 2 is selected and the photon count appears on the memory channel 2 trace 750. Pulses shown on the exposure time control trace 760 are used to set the desired exposure time and to control the shifting of the frame data between memory elements 670. The rising edge of the pulse initializes sampling the photon count into the first memory element 670 and shifting of the previous frame data to the respective next memory element 670. The falling edge of the same pulse is used to reset the photon counter 630 before the capture of the next frame. This time delay between sampling and resetting the counter, equal to the length of the pulse, ensures that all frame data can be successfully stored in the memory bank 660. As a result, an exposure time is equal to the time interval between the two rising edges of the pulses on the exposure time control trace 760.

The photon count captured in the given frame is shifted between all memory elements 670 in the activated memory bank 660, as can be seen on memory element 1 in bank 1 trace 770, memory element 2 in bank 1 trace 780, and memory element N in bank 1 trace 790. While memory bank 1 is used for the capture of the new frames, the memory bank 2 is selected for the readout, as the previous memory bank address trace 7130 is equal to the logic high. The photon counts captured for each frame in the previous series is available at the outputs of all memory elements 670 in the memory bank 2, as shown on memory element 1 in memory bank 2 trace 7100, memory element 2 in memory bank 2 trace 7110, and memory element N in memory bank 2 trace 7120. When the row select trace 7140 is equal to the logic high, the readout and pixel output driving circuits block 6130 settles the photon counts from all memory elements 670 in the memory bank 2 at the pixel output 250. Next, after N frames are captured in the memory bank 1, the memory bank address trace 730 toggles to the logic high activating the memory bank 2 for the capture of the next N frames. Consequently, the previous memory bank address trace 7130 toggles to the logic low, selecting memory bank 1 for the readout.

The implementation of the two-memory-bank pixel readout scheme may be varied and is not limited to SPAD-based pixels. Other possible embodiments include 4-transistor pixels with two analogue memory banks, 3-transistor pixels with two analogue memory banks, 3-transistor or 4-transistor pixels comprising an in-pixel analog-to-digital converter (ADC) and digital memory banks, and other pixel circuits. SPAD-based pixel implementations of the two-memory-bank pixel readout scheme may also vary. The pixel blocks shown in FIG. 6 can be implemented using different circuits providing the same functionality, for example the photon counter 630 can be implemented both as digital or analogue counter, providing the use of a suitable demultiplexer and memory bank circuits.

The timing diagram shown on the FIG. 7 is purely illustrative and may be varied, according to the implementation of the ultra-high-framerate continuous-readout SPAD pixel 610 and its readout scheme.

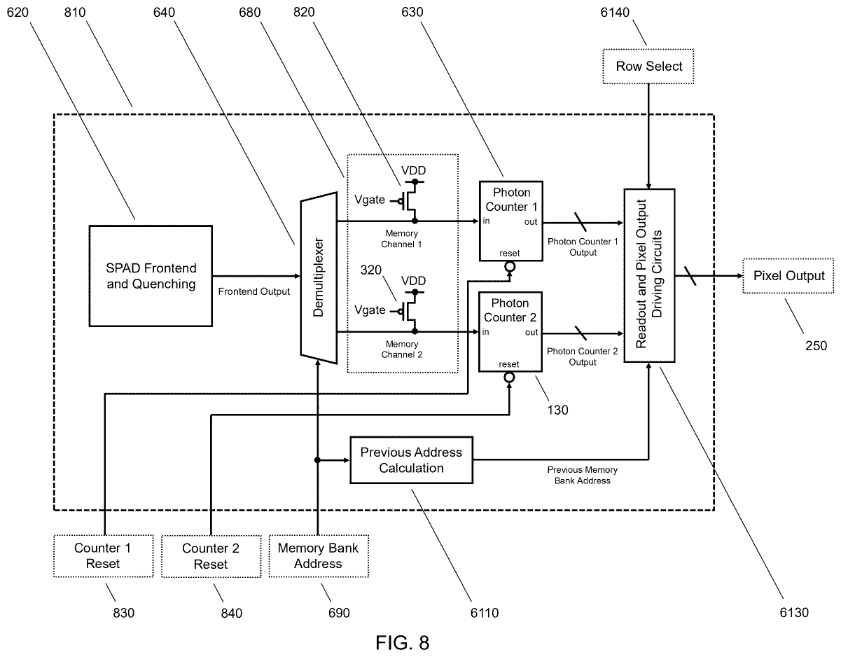

FIG. 8 shows a block diagram of an ultra-high-framerate continuous-readout SPAD pixel implemented with two photon counters 810. The two photon counters 630 are activated in the alternating fashion, allowing for the simultaneous capture of the photon count by one of them, while the other is available for the readout of the previously captured count out of the pixel. This pixel circuit allows for the continuous readout and gapless frame capture while having the advantage of a power and area-efficient design, provided the sensor row time is long enough to settle the photon count at the pixel output 250.

The ultra-high-framerate continuous-readout SPAD pixel implemented with two photon counters 810 shown on the FIG. 8 utilizes a SPAD device, which is interfaced to the pixel circuit by a SPAD quenching and frontend block 620. Output of the SPAD quenching and frontend block 620 is connected to a demultiplexer 640. Based on a memory bank address 690, one of the memory channels 680 is selected, connecting the output of the SPAD quenching and frontend block 620 to the photon counter 630. Memory bank address 690 is provided to the previous address calculation block 6110. Using the previous memory bank address, the readout and pixel output driving circuits block 6130 selects the photon counter 630 for the pixel readout. P-channel metal-oxide-semiconductor (PMOS) transistors 820 are used at the inputs to both photon counters 630 in order to ensure the captured photon count is not changing during the pixel readout, while the respective photon counter input is not driven by the demultiplexer 640. Counter 1 reset signal 830 and counter 2 reset signal 840 are used to reset the photon counter before the start of the capture of the next frame. Based on the row select signal 6140, the readout and pixel output driving circuits block 1130 outputs the photon counts to the pixel output 250.

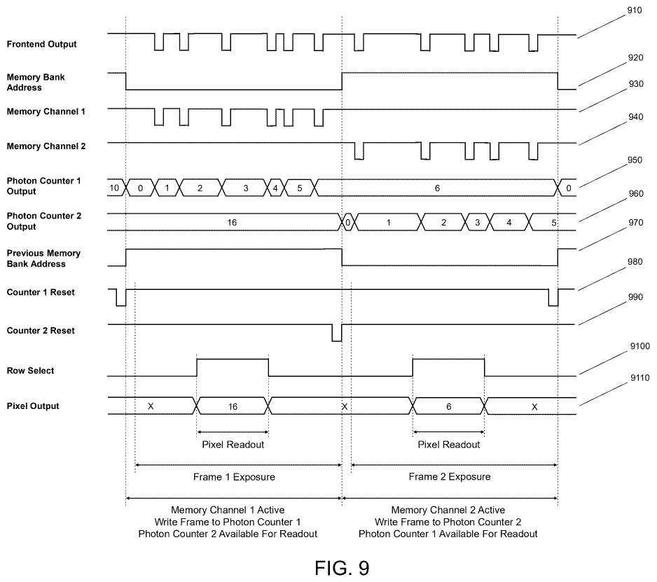

FIG. 9 shows a timing diagram of the ultra-high-framerate continuous-readout SPAD pixel implemented with two photon counters 810. A frontend output trace 910 shows a sample train of digital pulses representing detected incoming photons. Every falling edge of the frontend output trace 910 marks the arrival of a photon. When a memory bank address trace 920 is equal to the logic low, the train of pulses is demultiplexed to the memory channel 1, as shown on memory channel 1 trace 930. Conversely, when the memory bank address trace 920 is equal to the logic high, memory channel 2 is selected and the train of pulses is available at the memory channel 2 trace 940. Photon counter 1 output trace 950 and photon counter 2 output trace 960 show the rising photon counts, according to the incoming pulses.

When a previous memory bank address trace 970 is equal to the logic high, photon counter 2 is selected for the readout and the stored photon count is available for the readout and pixel output driving circuits block 6130. While the row select trace 9100 is equal to the logic high, the readout and pixel output driving circuits block 6130 settles the photon count at the pixel output 250. The logic low appearing on the counter 1 reset trace 980 and counter 2 reset trace 990 resets the respective photon count to 0 before the capture of the next frame. The falling edges of the counter reset pulses are aligned with the toggling of the memory bank address trace 920 to ensure counting of all arriving photons till the end of the given frame. An exposure time is equal to the time interval between the rising edge of the counter 1 reset trace 980 or counter 2 reset trace 990 and the next toggle of the memory bank address trace 920.

The implementation of the ultra-high-framerate continuous-readout SPAD pixel implemented with two photon counters 810 may be varied using any suitable circuits allowing to realize the desired pixel operation. The pixel blocks shown in FIG. 8 may be implemented using different circuits providing the same functionality, for example the photon counter 630 can be implemented both as digital or analogue counter, provided the use of a suitable demultiplexer and memory bank circuits.

The timing diagram shown on the FIG. 9 is purely illustrative and may be varied, according to the implementation of the ultra-high-framerate continuous-readout SPAD pixel implemented with two photon counters 810 and its readout scheme.

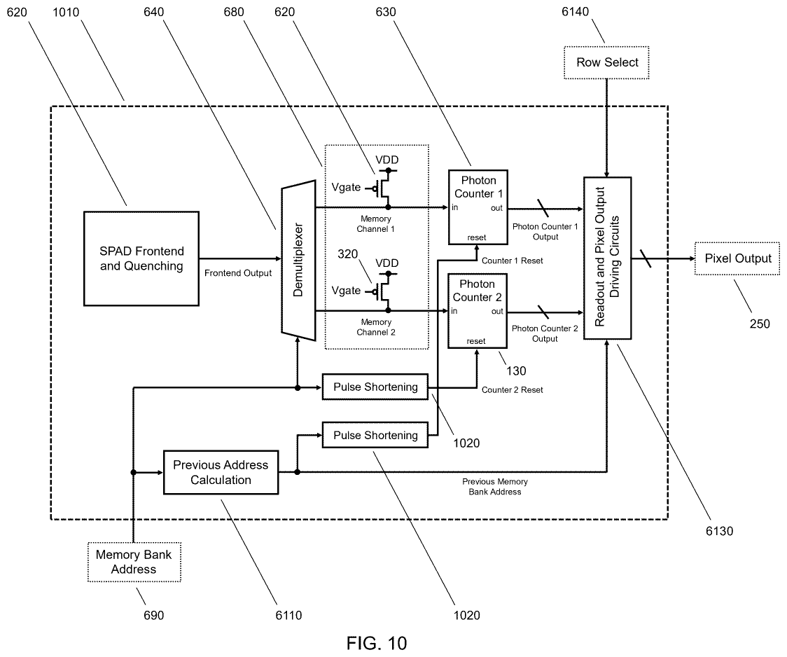

FIG. 10 shows a block diagram of an ultra-high-framerate continuous-readout SPAD pixel implemented with two photon counters without counter reset signal 1010. This pixel design eliminates the need for the external reset provided for the both counters. This is advantageous compared to the design shown in FIG. 8, as the usage of signal routing resources is decreased. The pixel block diagram is modified by adding pulse shortening blocks 1010. Their inputs are the memory bank address 690 and the previous memory bank address calculated by the previous address calculation block 6110. The shortened pulses are used as the reset signals for the photon counters 630 used for both memory channels 680. The pulse shortening blocks 1020 may be implemented as such as they allow for an externally-controllable length of the shortened pulse.

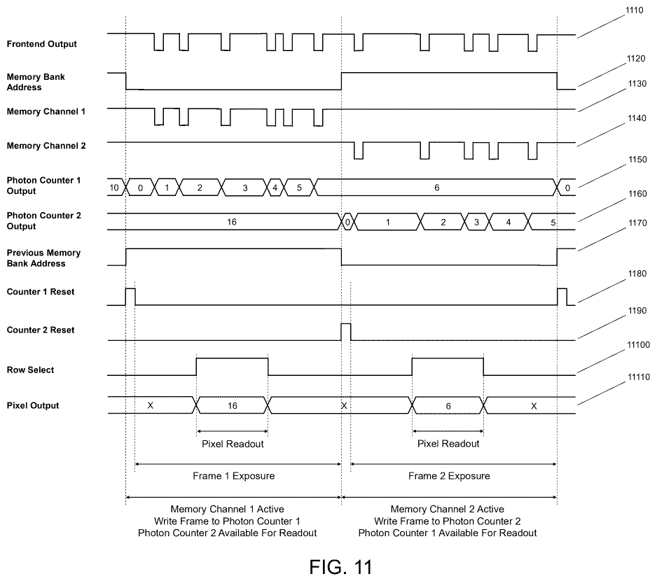

FIG. 11 shows a timing diagram of the ultra-high-framerate continuous-readout SPAD pixel implemented with two photon counters without counter reset signal 1010. A frontend output trace 1110 shows a sample train of digital pulses representing detected incoming photons. Every falling edge of the frontend output trace 1110 marks the arrival of a photon. When a memory bank address trace 1120 is equal to the logic low, the train of pulses is demultiplexed to the memory channel 1, as shown on memory channel 1 trace 1130. Conversely, when the memory bank address trace 1120 is equal to the logic high, memory channel 2 is selected and the train of pulses is available at the memory channel 2 trace 1140. Incoming photons are counted by the two alternating counters as shown on photon counter 1 output trace 1150 and photon counter 2 output 1160 trace.

When a previous memory bank address trace 1170 is equal to the logic high, photon counter 2 is selected for the readout and the stored photon count is available for the readout and pixel output driving circuits block 6130. While the row select trace 11100 is equal to the logic high, the readout and pixel output driving circuits block 6130 settles the photon count at the pixel output 250. Counter 1 reset trace 1180 and counter 2 reset trace 1190 are derived from the previous memory bank address trace 1170 and the memory bank address trace 1120 respectively by the pulse shortening blocks 1020. The logic high appearing on the counter 1 reset trace 1180 and counter 2 reset trace 1190 resets the respective photon count to 0 before the capture of the next frame. An exposure time is equal to the time interval between the falling edge of the said reset traces and the next toggle of the memory bank address trace 1120.

The implementation of the ultra-high-framerate continuous-readout SPAD pixel implemented with two photon counters without counter reset signal 1010 may be varied using any suitable circuits allowing to realize the desired pixel operation. The pixel blocks shown in FIG. 10 may be implemented using different circuits providing the same functionality, for example the photon counter 630 can be implemented both as digital or analogue counter, provided the use of a suitable demultiplexer and memory bank circuits.

The timing diagram shown on the FIG. 11 is purely illustrative and may be varied, according to the implementation of the ultra-high-framerate continuous-readout SPAD pixel implemented with two photon counters without counter reset signal 1010 and its readout scheme.

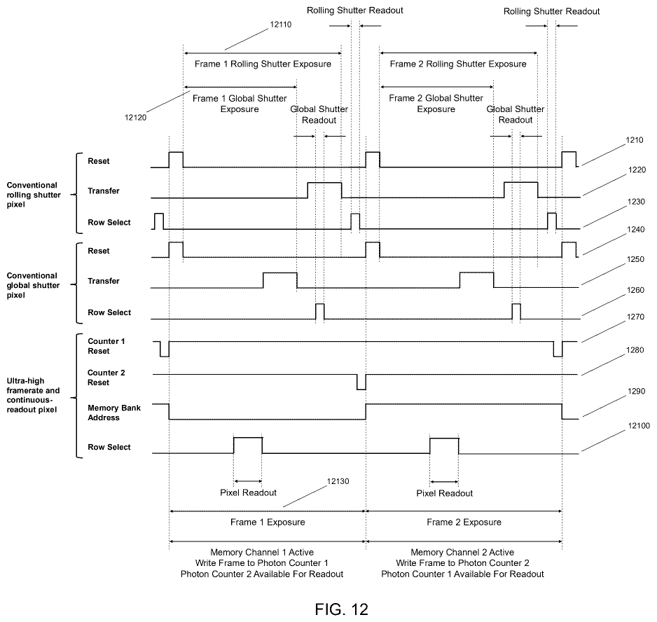

FIG. 12 shows the comparison of exposure times in state-of-the-art 4-transistor pixels and the ultra-high-framerate continuous-readout SPAD pixel implemented with two photon counters 810 in relation to the total frame time. Conventional CIS 4-transistor pixels provide rolling or global shutter operation mode. In this pixel architecture the photogenerated charges are transferred from a pinned photodiode to the sense node where a charge-to-voltage conversion is performed. In both modes, the maximum achievable exposure time is always shorter than the total frame time and is equal to the time span between the falling edge of the reset pulse and the falling edge of the transfer pulse. The rolling shutter exposure 12110 is longer than global shutter exposure 12120 for the same conventional 4-transistor pixel assuming the same total frame time allotted for the pixel operation. This is because the global shutter mode necessitates ending the exposure at the same time for all pixels in the pixel array and allowing a longer time for the combined readout of every row of pixels before the next exposure can start.

The exposure time 12130 of the ultra-high-framerate continuous-readout SPAD pixel implemented with two photon counters 810 can be equal to the total frame time, simultaneously allowing for the global shutter operation.

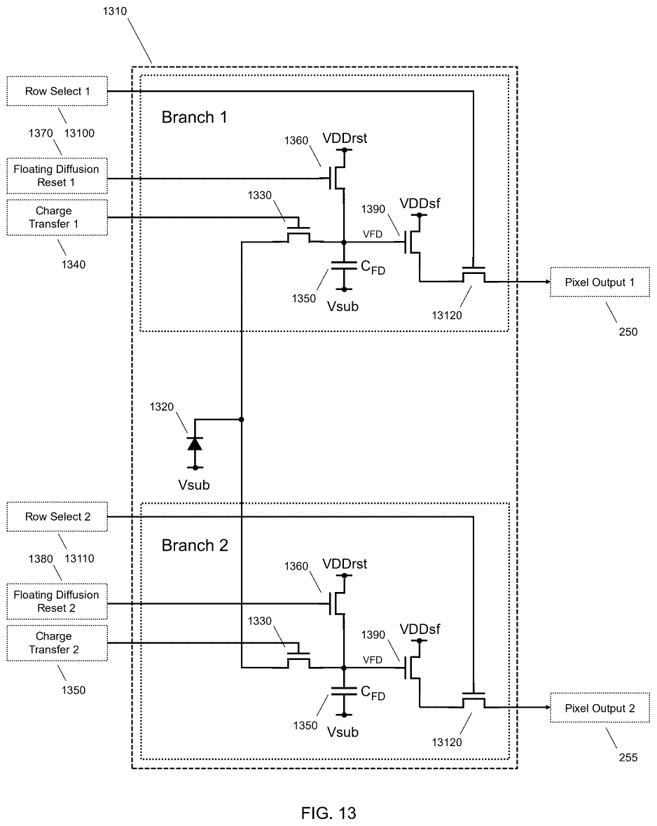

FIG. 13 shows a schematic diagram of an ultra-high-framerate continuous-readout pinned photodiode pixel using two transfer gates 1310. This pixel design may be seen as analogous to pixel 810 and pixel 1010, but employing a pinned photodiode 1320 as a radiation detector instead of a SPAD device.

The pixel 1310 operation is as follows. Before radiation intensity data for each new frame is acquired, a floating diffusion capacitance 1350 in one of the pixel branches is reset via a reset transistor 1360, based on floating diffusion reset signals 1370 and 1380. The floating diffusion capacitance 1350 is usually formed from parasitic capacitances of metal wires connecting the drain of a transfer gate transistor 1330 with the source of the reset transistor 1360 and the gate of a source follower transistor 1390, and parasitic capacitances of the transfer gate transistor 1330, the reset transistor 1360 and the source follower transistor 1390. Additional capacitors implemented with various different devices, such as metal-oxide-semiconductor (MOS) capacitor or metal-insulator-metal (MIM) capacitor might be added in order to increase the floating diffusion capacitance 1350. The voltage corresponding to the reset level of the node VFD is buffered via the source follower transistor 1390 when one of the row select signals 13100 and 13110 is set to logic high, turning on an enable transistor 13120. The buffered voltage corresponding to the reset level appears on one of pixel outputs 250 and 255, and may be further processed by any suitable circuitry outside of the pixel 1310, such as correlated double sampling (CDS) circuits or amplifiers.

After the voltage corresponding to the reset level is read out of the chosen pixel branch, the pinned photodiode 1320 is read out via the transfer gate transistor 1330 of a chosen pixel branch, transferring a charge corresponding to radiation intensity to the floating diffusion capacitance 1350. The transfer of the charge is controlled by charge transfer signals 1340 and 1350 provided to the gates of the transfer gate transistors 1330. Charge to voltage conversion is performed on the floating diffusion capacitance 1350, and resulting voltage corresponding to the detected radiation VFD is buffered via the source follower transistor 1390 when the corresponding row select signal 1340 or 1350 is set to logic high is set to logic high, turning on an enable transistor 13120. The buffered voltage corresponding to the detected radiation appears on one of pixel outputs 250 and 255, and may be further processed by any suitable circuitry outside of the pixel 1310, such as correlated double sampling (CDS) circuits or amplifiers. Simultaneously to the readout of the floating diffusion voltage VFD in one of the pixel branches, charge integration on the pinned photodiode 1320 and the transfer of a said charge to the floating diffusion capacitance 1350 are performed to obtain the radiation intensity data for the next frame, allowing for the continuous capture and readout of frames.

The implementation of the ultra-high-framerate continuous-readout pinned photodiode pixel using two transfer gates 1310 may be varied. The pixel shown in FIG. 13 can be implemented using different circuits and devices providing the same functionality. The pixel outputs 250 and 255 may be shunt together and routed out of the pixel using a single wire to provide a more compact implementation.

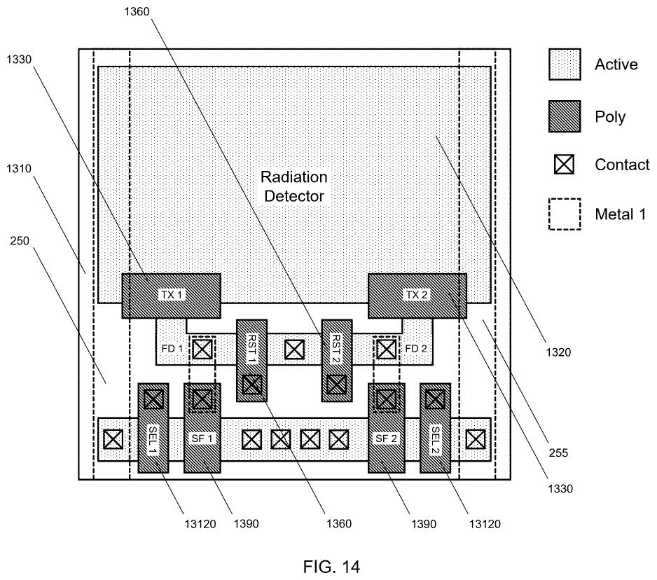

FIG. 14 shows an example layout of an ultra-high-framerate continuous-readout pinned photodiode pixel using two transfer gates 1310. Two branches of said pixel 1310 are laid out below the pinned photodiode 1320, symmetrically at two sides of the pixel 1310. In order to achieve a high charge-to-voltage conversion factor (CVF), parasitic capacitances at the floating diffusion node 1350 are minimized by placing the contact connecting the drain of the transfer gate 1330 to the first metal layer, close to the gate of the source follower 1390. The disclosed pixel layout is suitable for a minimum 5-8 μm pixel pitch implementation in ≤180 nm monolithic CIS technologies. Achieved pixel fill factor is 50%. One skilled in the art may recognize that said pixel layout is suited for manufacturing in back-side-illuminated (BSI) CIS technologies, which further improves the pixel sensitivity.

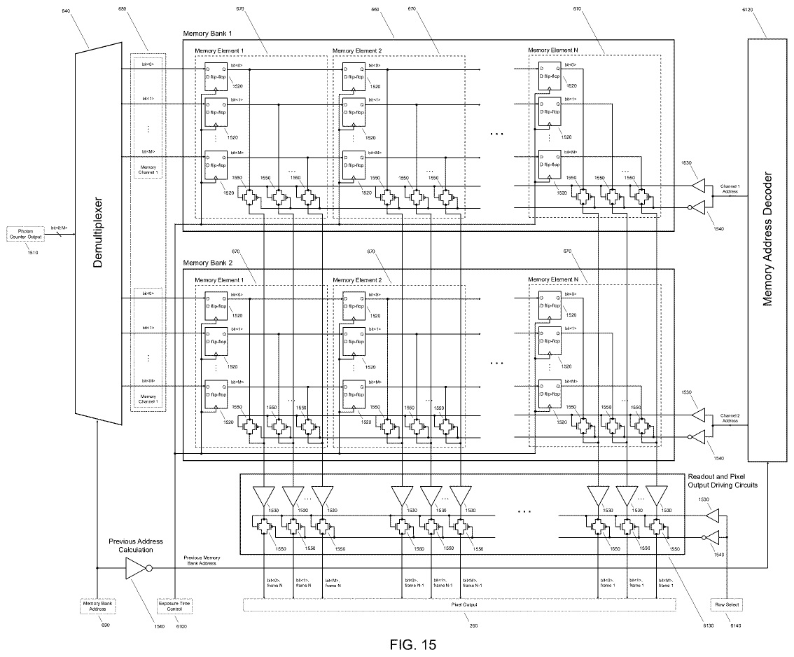

FIG. 15 shows a memory circuit implemented as shift registers. This implementation benefits from the data shifting operation natively available for the shift register circuit, readily for use in the ultra-high-framerate and continuous-readout pixel 610. A photon counter output 1510 consisting of M bits is demultiplexed by the demultiplexer 640 into one of the memory channels 680, based on the memory channel address signal 690. Each of said channels 680 is connected to the inputs of the first memory element 670 of each memory bank 660. The memory element 670 is implemented as M parallel D flip flops 1520, corresponding to the M bits in the photon counter output 1510. Outputs Q of the D flip flops 1520 are daisy-chain-connected to the inputs D of said D flip flops 1520 in the next memory element 670 in the memory bank 660. Exposure time control signal 6100 is provided to the clock input of all D flip flops 1520 in every memory element 670, enabling the shifting of all data bits between the memory elements. The shifting operation may be triggered by the rising or falling edge of the exposure time control signal 6100, depending on the used implementation of the D flip flop 1520.

Memory channel address signal 690 is provided to the previous address calculation block 6110, implemented as an inverter 1540. Calculated previous memory bank address is input to the memory address decoder 6120. A decoded memory channel address is provided to a buffer 1530 and an inverter 1540, driving respectively an n-channel metal-oxide-semiconductor (NMOS) transistor and a PMOS transistor, consisting of a transmission gate 1550, acting as a select switch for every of the M bits stored in each memory element 670. When said transmission gate 1550 is closed, the M bits are settled on the column wires connected to the readout and pixel output driving circuits block 6130. Said block may be implemented as N groups of M buffers 1530, having transmission gates 1550 connected to their outputs and acting as a select switch. The row select signal 6140 is connected to a buffer 1530 and an inverter 1540, driving respectively an NMOS transistor and a PMOS transistor in the transmission gates 1550. The readout and pixel output driving circuits block 6130 is driving the pixel output 250, consisting of M times N bits, for all N frames stored in the memory bank 660.

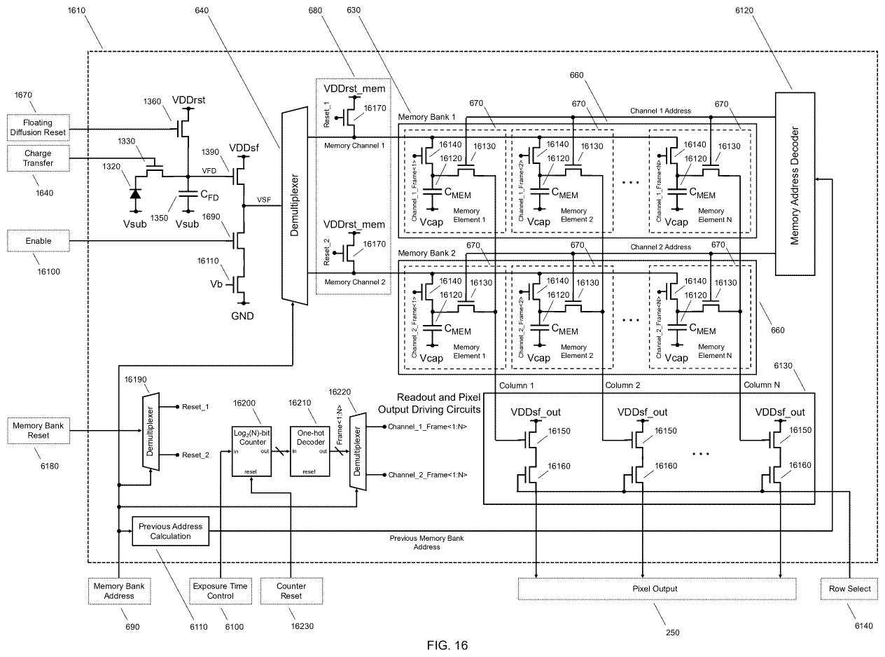

FIG. 16. shows a block diagram of an ultra-high-framerate continuous-readout pinned photodiode pixel 1610. Before radiation intensity data for each new frame is acquired, a floating diffusion capacitance 1350 is reset via a reset transistor 1360, based on a floating diffusion reset signal 1670. Additional capacitors implemented with various different devices, such as MOS capacitor or MIM capacitor might be added in order to increase the floating diffusion capacitance 1350. The voltage corresponding to the reset level of the node VFD is buffered via the source follower transistor 1390 when an enable signal 16100 is set to logic high, turning on an enable transistor 1690. A bias voltage Vb provides a suitable bias for a current source transistor 16110. The buffered voltage corresponding to the reset level settles on the node VSF, i.e. the input of the demultiplexer 640.

Based on the memory bank address 690, one of the memory channels 680 is selected and used to store the voltage corresponding to the reset level for each frame in the series. The memory channels 680 are connected to the two memory banks 660, storing the voltage in the memory element 670.

After the voltage corresponding to the reset level is stored in the memory element 670 in the active memory bank 660, a pinned photodiode 1320 is read out via the transfer gate transistor 1330 transferring a charge corresponding to radiation intensity to a floating diffusion capacitance 1350. The transfer of the charge is controlled by the charge transfer signal 1640 provided to the gate of the transfer gate transistor 1330. Charge to voltage conversion is performed on the floating diffusion capacitance 1350, and resulting voltage corresponding to the detected radiation VFD is buffered via a source follower transistor 1380 when the enable signal 16100 is set to logic high is set to logic high, turning on an enable transistor 1690. The buffered voltage corresponding to the detected radiation settles on the node VSF, i.e. the input of the demultiplexer 640, ready to be stored in the next memory element 670.

As further depicted in FIG. 16, said memory element 670 may be implemented using a memory capacitance 16120, an access transistor 16140 and a readout transistor 16130. The memory capacitance 16120 may be implemented in any suitable way, for example using a MOS capacitor, MIM capacitor, metal-oxide-metal (MOM) capacitor or parasitic capacitances of suitable devices and metal wires available in a complementary metal-oxide-semiconductor (CMOS) process used for manufacturing of the pixel. In order to store the voltage in a chosen memory element 670, the desired access transistor 16140 is turned on by asserting a suitable voltage level on its gate. This is achieved with the exposure time control signal 6100 having its frequency twice as high as the desired framerate. The exposure time control signal 6100 is input to an Log₂(N)-bit counter 16200. At every toggle of the exposure time control signal 1100 the count stored in the Log₂(N)-bit counter 16200 increases by one. The output state of the counter is input to a suitable one-hot decoder 16210. The decoded state Frame<1:N> is directed to the gates of N access transistors 16140 in the memory elements 670 of the currently active memory bank 660 by a demultiplexer 16220. Thus, at every toggle of the exposure time control signal 6100, a new memory element 670 is accessed allowing to store the voltage corresponding to the reset level or the detected radiation. Inside the N-memory-element memory bank N/2 frames containing both reset levels and detected radiation can be stored.

In some embodiments, it may be desirable to store only the voltages corresponding to the detected radiation and disregard the reset voltages, thus increasing the capacity of the N-memory element bank to N frames.

In some embodiments, a counter reset signal 16230 may be used in order to reset the Log₂(N)-bit counter 16200 at the start or at the end of the pixel operation.

Before storing a new voltage, the memory element 670 must be reset to the VDDrst_mem voltage, clearing all previously stored information. This is achieved by asserting a suitable voltage on the gate of a memory reset transistors 16170 in a selected memory channel 680, while the desired memory element 670 is accessed and shortly before asserting a logic high on the gate of the enable transistor 16100. Memory bank reset signal 16180 is provided to the demultiplexer 16190, which is directing it to the desired memory channel 680, based on the memory bank address signal 690.

Memory bank address 690 is provided to the previous address calculation block 6110. Based on the calculated previous memory bank address, memory address decoder 6120 selects the memory bank 660 for the pixel readout. While the voltages corresponding to the new frames are being written to one of the memory banks 660, the other bank is used to readout the previously stored N frames out of the pixel circuit. As shown in FIG. 16, this may be achieved by asserting a suitable voltage level on the gates of the readout transistors 16130 in memory elements 670 inside a desired memory bank 660. The voltages stored on memory capacitances 16120 in memory elements 670 inside a desired memory bank 660 are made available on the column buses connecting memory banks 660 to the readout and pixel output driving circuits block 6130. Based on a row select signal 6140, the readout and pixel output driving circuits block 6130 outputs the voltages to the pixel output 250.

As further depicted in FIG. 16, said readout and pixel output driving circuits block 6130 may be implemented using source follower transistors 16150 and row select transistors 16160. Row select transistors are operated as switches connecting sources of the source follower transistors 16150 with the wires composing the pixel output 250.

The implementation of the ultra-high-framerate continuous-readout pinned photodiode pixel 1610 may be varied. The pixel blocks shown in FIG. 16 can be implemented using different circuits providing the same functionality.

In some embodiments, the ultra-high-framerate continuous-readout SPAD pixel 610 or the ultra-high-framerate continuous-readout SPAD pixel implemented with two photon counters 810 or the ultra-high-framerate continuous-readout SPAD pixel implemented with two photon counters without counter reset signal 1010 or the ultra-high-framerate continuous-readout pinned photodiode pixel using two transfer gates 1310 or ultra-high-framerate continuous-readout pinned photodiode pixel 1610 may comprise a layered integrated circuit (IC) architecture. In such an embodiment, the SPAD device or pinned photodiode circuitry comprising the pinned photodiode 1320 may comprise the topmost or of the layered IC architecture in order to maximize the sensitivity to radiation. All other pixel blocks and circuits, including memory banks 660, may be included on layers of the layered IC architecture below the SPAD device or the pinned photodiode 1320.

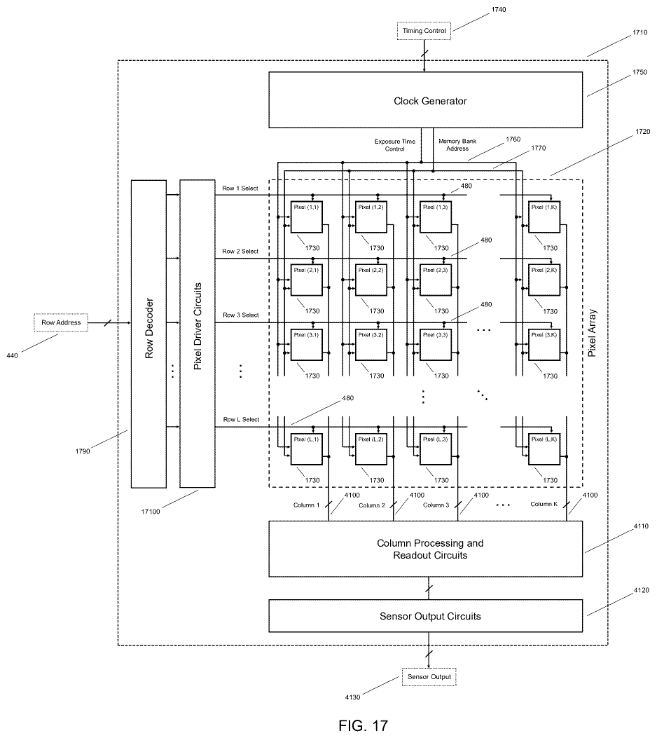

FIG. 17 shows a block diagram of an ultra-high-framerate and continuous-readout image sensor 1710. The pixel array 1720 is composed of L by K pixels 1730. A plurality of timing control signals 1740 may be provided to the clock generator block 1750, which generates an exposure time control signal 1760 and a memory address signal 1770. The said signals are distributed to every pixel 1730 in the pixel array 1720.

A row address signal 440 is provided to the row address block 1790. Said block decodes the row address signal 440 into a suitable input for a pixel driver circuits block 17100, selecting a desired row for the readout. The pixels are driven by the pixel driver circuits block 17100 providing the row select signal 480 to every pixel row.

The outputs of the pixels are organized in columns 4100, which may be implemented as buses composed of a plurality of parallel wires. The columns 4100 are input to the column readout and processing block 4110. The said block is connected to the sensor output circuits block 4120 providing the sensor output signal 4130 containing the frame data.

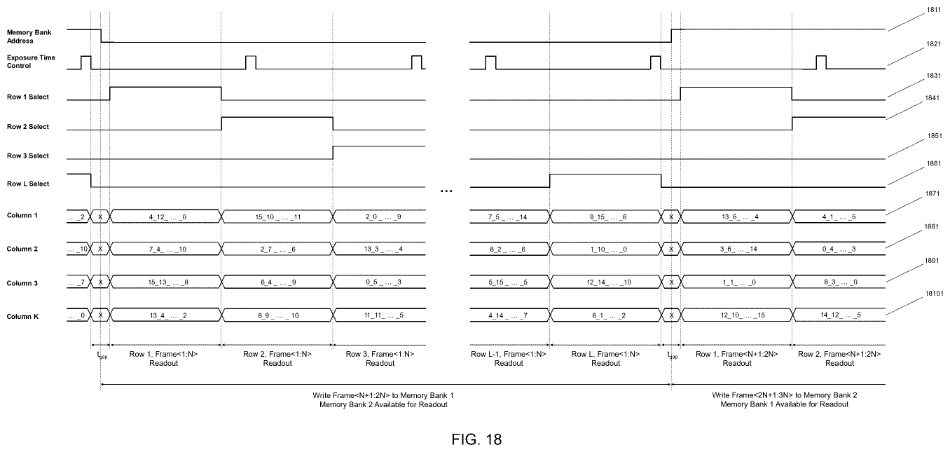

FIG. 18 shows a timing diagram of the ultra-high-framerate and continuous-readout image sensor 1710. Memory bank address trace 1811 selects the memory bank 660 in all said pixels 1730 for capturing the frame data. Pulses shown on the exposure time control trace 1821 are used to set the desired exposure time and control shifting of the frame data between memory elements 670 inside the pixels 1730. A pulse is given on row 1 select trace 1831, row 2 select trace 1841, row 3 select trace 1851 and row L select trace 1861, in order to select a given row of pixels for the readout. While each of the said traces is equal to the logic high, the photon counts from all memory elements 670 in the currently selected memory bank 660 in all said pixels 1730 in the selected row are settled on the columns 4100. The photon counts appear on column 1 trace 1871, column 2 trace 1881, column 3 trace 1891, and column K trace 18101. The row select pulse is non-overlapping between the adjacent pixel rows, ensuring that the correct pixel counts are settled on the columns 4100 and no excess power is used while two different readout and pixel output driving circuits blocks 6130 are driving the same column 4100 at the same time.

While this detailed description has set forth some embodiments of the present invention, the appended claims cover other embodiments of the present invention which differ from the described embodiments according to various modifications and improvements. For example, one skilled in the art may recognize that such principles may be applied to any sensing device detecting radiation intensity, regardless of employed radiation detector or the implementation of the memory banks. Example radiation detectors include SPADs, pinned photodiodes, photodiodes, phototransistors, photogates, and so on. Example implementations of the memory banks include shift registers, static random-access memory (SRAM), dynamic random-access memory (DRAM), analog memories, and so on.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A memory circuit for an ultra-high-framerate continuous-readout pixel comprising:
two memory banks operated in an interleaved way, while one is receiving radiation intensity information and the other is being read out;
a demultiplexer directing the radiation intensity data to either odd memory bank or even memory bank according to a memory bank address signal;
a memory address decoder choosing said memory bank for the read out; and
a readout and pixel output driving circuits block driving the output terminals of the memory circuit based on a row select signal;
wherein the radiation intensity data is input to the demultiplexer, the outputs of said demultiplexer are connected to the inputs of said memory banks, and the outputs of said memory banks are connected to said readout and pixel output driving circuits block.

2. The memory circuit for an ultra-high-framerate continuous-readout pixel of claim 1, wherein the memory bank comprises a shift register circuit.

3. The memory circuit for an ultra-high-framerate continuous-readout pixel of claim 1, wherein the memory bank comprises an asynchronous digital counter circuit.

4. The memory circuit for an ultra-high-framerate continuous-readout pixel of claim 1, wherein the memory bank comprises a synchronous digital counter circuit.

5. The memory circuit for an ultra-high-framerate continuous-readout pixel of claim 1, wherein the memory element comprises a photon counting circuit.

6. The memory circuit for an ultra-high-framerate continuous-readout pixel of claim 1, wherein the memory element comprises a plurality of static random access memory cells and suitable memory supporting circuits for read and write operations.

7. The memory circuit for an ultra-high-framerate continuous-readout pixel of claim 1, wherein the memory element comprises a plurality of dynamic random access memory cells and suitable memory supporting circuits for read and write operations.

8. The memory circuit for an ultra-high-framerate continuous-readout pixel of claim 1, wherein the memory element comprises any suitable digital or analogue memory circuit.

9. A method of operating the memory circuit for an ultra-high-framerate continuous-readout pixel comprising:
setting a demultiplexer to direct the radiation intensity data to the odd memory bank;
writing the radiation intensity data to the odd memory bank for a number of N frames;
simultaneously reading out a previously stored series of N frames from the even memory bank to the outside of the memory circuit;
setting a demultiplexer to direct the radiation intensity data to the even memory bank once the writing of the N frames to the odd memory bank is complete;
writing the radiation intensity data to the even memory bank for a number of N frames;
simultaneously reading out a previously stored series of N frames from the odd memory bank to the outside of the memory circuit; and
repeating said steps as long as needed for the desired number of frames to be recorded.

10. The method of operating the memory circuit for an ultra-high-framerate continuous-readout pixel of claim 9, applied in order to achieve the gapless exposure to the radiation, and applicable to any gapless exposure image sensor, not limited to the ultra-high-framerate image sensors and cameras.

11. An ultra-high-framerate continuous-readout pixel comprising:
a sensing device converting the input radiation intensity into an electrical signal;
frontend circuits biasing and reading out the sensing device; and
a memory circuit comprising:
two memory banks working in an interleaved way, while one is receiving radiation intensity information and the other is being read out;
a demultiplexer directing the radiation intensity data to either odd memory bank or even memory bank according to the memory bank address signal;
a memory address decoder choosing said memory bank for the read out; and
a readout and pixel output driving circuits block driving the output terminals of the memory circuit based on the row select signal;
wherein the radiation intensity data is input to the demultiplexer, the outputs of said demultiplexer are connected to the inputs of said memory banks, and the outputs of said memory banks are connected to said readout and pixel output driving circuits block;
wherein the output of said sensing device is input to the frontend circuits, and the output of said frontend circuit is connected to the inputs of said memory circuits.

12. The ultra-high-framerate continuous-readout pixel comprising of claim 11, further comprising:
a first layer comprising a top surface exposed to an external environment; and
a second layer adjacent a bottom surface of the first layer, opposite the top surface;
wherein the sensing device is disposed on the first layer of the ultra-high-framerate continuous-readout pixel, and
wherein the frontend circuits and memory circuit are disposed on the second layer of the ultra-high-framerate continuous-readout pixel.

13. The ultra-high-framerate continuous-readout pixel comprising of claim 11, further comprising:
a first layer comprising a top surface exposed to an external environment; and
a second layer adjacent a bottom surface of the first layer, opposite the top surface;
wherein the sensing device and frontend circuits are disposed on the first layer of the ultra-high-framerate continuous-readout pixel, and
wherein the memory circuit is disposed on the second layer of the ultra-high-framerate continuous-readout pixel.

14. An ultra-high-framerate continuous-readout image sensor comprising:
a pixel array comprising a plurality of pixels arranged in a two-dimensional shape comprising rows and columns, each pixel comprising:
a sensing device converting the input radiation intensity into an electrical signal;
frontend circuits biasing and reading out the sensing device; and
a memory circuit comprising;
two memory banks working in an interleaved way, while one is receiving radiation intensity information and the other is being read out;
a demultiplexer directing the radiation intensity data to either odd memory bank or even memory bank according to the memory bank address signal;
a memory address decoder choosing said memory bank for the read out; and
a readout and pixel output driving circuits block driving the output terminals of the memory circuit based on the row select signal;
wherein the radiation intensity data is input to the demultiplexer, the outputs of said demultiplexer are connected to the inputs of said memory banks, and the outputs of said memory banks are connected to said readout and pixel output driving circuits block;
wherein the output of said sensing device is input to the frontend circuits, and the output of said frontend circuit is connected to the inputs of said memory circuits.
